(19) United States
(12) Patent Application Publication
(10) Pub. No.: US 2025/0317774 A1
(43) Pub. Date: Oct. 9, 2025

(54) Performing Sensing Measurements during a Sensing Session between a First Wireless STA and a Second Wireless STA in a Wireless Communication Network

(71) Applicant: Telefonaktiebolaget LM Ericsson (pub), Stockholm (SE)

(72) Inventors: Leif Wilhelmsson, Lund (SE); Miguel Lopez, Aachen (DE)

(21) Appl. No.: 18/865,032

(22) PCT Filed: May 19, 2022
(86) PCT No.: PCT/EP2022/063529

§ 371 Date: Nov. 12, 2024

(51) Int. Cl. H04W 24/10; H04W 76/15; H04W 84/12

(52) U.S. Cl. CPC H04W 24/10; H04W 76/15; H04W 84/12

(57) ABSTRACT

A method of reporting sensing measurements between a first wireless station, STA, and a second wireless STA in a Wireless Communication Network, said method comprises the steps of selecting, in a sensing session setup, said first wireless STA as a sensing transmitter STA for transmitting frames, and said second wireless STA as a sensing receiver STA for performing measurements on frames received from said sensing transmitter STA, wherein said step of selecting is based on expected accuracy of said sensing measurements, performing, by the sensing receiver STA, during a sensing session, wireless sensing thereby obtaining sensing measurements, by performing measurements on frames received from said sensing transmitter STA, reporting, by the sensing receiver STA, said obtained sensing measurements to said sensing transmitter STA.

### TECHNICAL FIELD

The present disclosure generally relates to the field of wireless communications and, more specifically, to wireless sensing performed in wireless communication networks.

### BACKGROUND

The Institute of Electrical and Electronics Engineer (IEEE) working group 802.11 has initiated a task group (TG) 802.11bf that defines an amendment for wireless sensing. IEEE 802.11bf will define methods for exchanging IEEE 802.11 transmissions, also denoted as frames, between IEEE 802.11bf compliant devices, which are called stations, STAs. The exchanged frames enable STAs to sense their environment. With wireless sensing, STAs are capable to detect motion, the presence of human beings and pets, the position of doors, and potentially aspects like pulse rate and respiratory rate.

802.11bf introduces so-called “WLAN sensing procedures”. Such procedures enable a STA to perform sensing and/or obtain measurement results. A WLAN sensing procedure comprises one or more of: sensing session setup, sensing measurement instance, sensing measurement setup termination, and sensing setup termination.

A STA that initiates a sensing procedure is called a sensing initiator, while a STA that participates in a sensing procedure started by an initiator is called a sensing responder. A sensing transmitter is a STA that transmits physical layer protocol data units, PPDUs, used for sensing measurements, and a sensing receiver is a STA that receives a PPDU transmitted by a sensing transmitter and performs measurements in a WLAN sensing procedure. A STA can have multiple roles in a WLAN sensing procedure. In a sensing session setup, the operational parameters associated with the sensing session are determined and exchanged among STAs.

When the sensing receiver is not consuming the measurements, it sends a sensing measurement report frame to report the measurements. A sensing measurement report frame comprises a measurement report field which carries channel state information, CSI, measurements obtained by a sensing receiver, and a control field that contains information describing how to interpret the measurement report field. Examples of information needed to interpret the CSI measurements include resolution, for example in bits, bandwidth and number of RX chains.

The IEEE 802.11 devices operate in license exempt frequency bands, also sometimes referred to as unlicensed frequency bands. One of the key characteristics of license exempt bands is that the interference due to transmissions by other devices is highly unpredictable. Specifically, for a communication link the interference experienced by the transmitter and the receiver may be very different as the interferer may be positioned close to the receiver but relatively far from the transmitter, or vice versa.

One of the challenges related to wireless sensing is how to obtain the most reliable sensing results.

### SUMMARY

It is an object of the present disclosure to provide for methods of performing sensing measurements during a sensing session between a first wireless station, STA, and a second wireless STA in a Wireless Communication Network. It is a further object of the present disclosure to provide for corresponding wireless stations as well as a corresponding computer program product.

In a first aspect, there is provided a method of performing sensing measurements during a sensing session between a first wireless station, STA, and a second wireless STA in a Wireless Communication Network, said method comprises the steps of:
selecting, in a sensing session setup, said first wireless STA as a sensing transmitter STA for transmitting frames, and said second wireless STA as a sensing receiver STA for performing measurements on frames received from said sensing transmitter STA, wherein said step of selecting is based on expected accuracy of said sensing measurements;
performing, by the sensing receiver STA, during a sensing session, wireless sensing thereby obtaining sensing measurements, by performing measurements on frames received from said sensing transmitter STA.

In an example, the method comprises the step of:
reporting, by the sensing receiver STA, said obtained sensing measurements, or information derived from said obtained sensing measurements, to said sensing transmitter STA.

The inventors have found that it may be beneficial to use the basic principle that the channel is reciprocal, i.e. the channel between two stations is the same independent of which one of the two stations is the transmitter and receiver, respectively.

The above insight may be implemented to determine the roles of the two stations in the process. That is, which station is assigned the role as the sensing transmitter station and which station is assigned the role as the sensing received station.

Determining which station takes the role of the sensing transmitter station and which station takes the role of the sensing receiver station may then be based on expected accuracy of the corresponding sensing measurements. This is beneficial as this increases the reliability of the obtained measurement results.

The above may be explained as follows. The obtained measurement results depend on the wireless channel between the two wireless stations, but also depend on other factors. It is not merely the channel that is responsible for obtaining accurate sensing results, but also these other factors.

The decision which station takes which role may then be based, at least to a certain extent, on these other factors. Examples of these other factors may include, for example, actual and/or expected interference experienced by any of said first wireless STA and said second wireless STA and the transmit power of any of said first wireless STA and said second wireless STA.

The two wireless stations are spaced apart from each other at a certain distance. As a result, the two wireless station may experience different levels of interference from other wireless devices that are in their vicinity. These other wireless devices may also be wireless stations that are able to transmit in a same frequency band as the two wireless stations or may be any other wireless device that is able to transmit in the same frequency band as the two wireless stations.

Following the above, it may be beneficial to choose the wireless station that has the least interference as the sensing receiver station.

For example, the station that experiences the least amount of interference may be provided with the role of the sensing receiver station to perform the sensing as this can be expected to result in higher accuracy.

It is noted that the above described interference may be related to the actual interference experienced by the stations or the expected interference experienced by the stations. The expected interference may, for example, be determined based on repetitive, i.e. periodically returning, interference originating from other station in the vicinity or be based on e.g. the fraction of time that a STA experience interference above a certain level.

Another example is related to the transmit power of each of the wireless stations. The transmit powers of the two wireless stations may be different, for example due to the type of wireless stations and/or regulated by local jurisdictions. An Access Point, AP, is a type of a wireless stations and an AP may, typically, have a higher transmit power compared to non-AP types of wireless stations.

In an example, the step of selecting comprises at least one of:
exchanging, in said sensing session setup, transmit power(s) of any of said first and second wireless STA between said first and second wireless STA;
exchanging, in said sensing session setup, actual and/or expected interference experienced by any of said first and second wireless STA between said first and second wireless STA.

The above described actual and/or expected interference as well as the transmit power(s) of the stations may be known a priori by each of the wireless stations.

Alternatively, this kind of information may be exchanged between the wireless stations during a handshaking process. The handshaking process usually takes place in order to establish rules for communication when two wireless stations attempt to communicate with each other.

The ultimate decision with respect to the different roles may be taken by any of the two stations, or the decision may be taken in a distributed manner. Taking the decisions in a distributed manner is possible as long as the decision making parameters are the same between each of the stations. In such case, each of the stations will make a decision that is uniform between the stations.

Another option is that during the handshaking process it is decided which of the two wireless stations is responsible for making the ultimate decision on who takes what role during the sensing session.

In a further example, the actual and/or expected interference relates to any of:
an average fraction of time that the first wireless STA and/or the second wireless STA is interfered,
a maximum interference that the first wireless STA and/or the second wireless STA is expected to experience, or
an expected distribution for the interference that the first wireless STA and/or the second wireless STA is expected to experience.

In another example, the step of selecting comprises:
selecting, by said sensing receiver STA, in said sensing session setup, said first wireless STA as said sensing transmitter STA and said second wireless STA as said sensing receiver STA during a first part of said sensing session and selecting said first wireless STA as said sensing receiver STA and said second wireless STA as said sensing transmitter STA during a second part of said sensing session.

The inventors have found that, in order to even improve the reliability of the sensing measurements, it may be beneficial to swap the roles of the two stations during the sensing session. That is, during the sensing session the roles may alternate between the two wireless stations. The measurement results obtained by each of the two stations may, for example, then be averaged to obtain a final measurement results. More generally, the measurement results may be combined in a way that take into account the reliability of the measurements performed in the different directions.

In yet another example, the first wireless STA and said second wireless STA are dual-link capable such that said first wireless STA and said second wireless STA are capable of transmitting and receiving over two links simultaneously.

In accordance with the present disclosure, the above may entail that the two wireless stations are able to transmit and receive in two different frequency bands simultaneously. That is, the wireless stations may, for example, operate in two distinct frequency channels simultaneously.

In a detailed example hereof, the step of selecting comprises:
selecting, by said sensing receiver STA, in said sensing session setup, said first wireless STA as said sensing transmitter STA and said second wireless STA as said sensing receiver STA for a first of said two links, and
selecting, by said sensing receiver STA, in said sensing session setup, said first wireless STA as said sensing receiver STA and said second wireless STA as said sensing transmitter STA for a second of said two links.

In another example, the step of performing comprising performing said wireless sensing for both of said two links simultaneously.

In yet another example, the sensing measurements comprise any of:
Channel State Information, CSI;
Control field comprising information describing how to interpret said sensing measurements.

In wireless communications, channel state information may refer to channel properties of a wireless communication channel. This information describes how a signal propagates from the transmitter station to the receiver station and represents the combined effect of, for example, scattering, fading, and power decay with distance. The method to obtain knowledge of how a signal is impacted by the channel is called Channel estimation. Many different types of channel estimation exist, for example blind estimation or estimating the channel with a priori known reference symbols. The CSI may for example describe the channel in the frequency domain, by means of the amplitude and the phase for different frequency components of the channel, or the CSI may describe the channel by means of the channel impulse response.

The CSI makes it possible to adapt transmissions, from the transmitter station to the receiver station, to current channel conditions, which is beneficial for achieving reliable communication with high data rates in multiantenna systems. CSI may e.g. be estimated at the sensing receiver station and usually quantized and fed back, i.e. reported back, to the sensing transmitter station.

The control field may comprise a single bit, or a string, which indicates to the sensing transmitter station how to interpret the sensing measurements.

In a second aspect of the present disclosure, there is provided a method for requesting sensing measurements, by a first wireless station, STA, from a second wireless STA, in a wireless communication network, said method comprises the steps of:
selecting, in a sensing session setup, said first wireless STA as a sensing transmitter STA for transmitting frames, and said second wireless STA as a sensing receiver STA for performing measurements on frames received from said sensing transmitter STA, wherein said step of selecting is based on expected accuracy of said sensing measurements;
requesting, by said sensing transmitter STA, said second wireless STA to perform, during a sensing session, wireless sensing thereby obtaining sensing measurements, by performing measurements on frames received from said transmitter STA.

In an example, the method comprises the step of:
receiving, by said sensing transmitter STA, said obtained sensing measurements, or information derived from said obtained sensing measurements, from said sensing receiver STA.

It is noted that the advantages as explained with respect to the first aspect, being the method of performing sensing measurements during a sensing session between a first STA and a second STA are also applicable to the second aspect, being the method for receiving sensing measurement by a first STA from a second STA.

In a third aspect of the present disclosure, there is provided a second wireless STA, arranged for performing sensing measurements in a sensing session between a first wireless STA and the second wireless STA, in a wireless communication network, said second wireless STA comprises:
select equipment arranged for selecting, in a sensing session setup, said first wireless STA as a sensing transmitter STA for transmitting frames, and said second wireless STA as a sensing receiver STA for performing measurements on frames received from said sensing transmitter STA, wherein said step of selecting is based on expected accuracy of said sensing measurements;
processing equipment arranged for performing, during a sensing session, wireless sensing thereby obtaining sensing measurements, by performing measurements on frames received from said transmitter STA.

In an example, the second wireless STA comprises
report equipment arranged for reporting said obtained sensing measurements, or information derived from said obtained sensing measurements, to said transmitter STA.

It is noted that the advantages as explained with respect to the first aspect, being the method of performing sensing measurements during a sensing session between a first STA and a second STA are also applicable to the third aspect, being the second wireless STA, arranged for performing sensing measurements, in a wireless communication network.

In a fourth aspect of the present disclosure, there is provided a first wireless STA, arranged for requesting sensing measurements from a second wireless STA, in a wireless communication network, said first wireless STA comprises:
select equipment arranged for selecting, in a sensing session setup, said first wireless STA as a sensing transmitter STA for transmitting frames, and said second wireless STA as a sensing receiver STA for performing measurements on frames received from said sensing transmitter STA, wherein said step of selecting is based on expected accuracy of said sensing measurements;
transmit equipment arranged requesting said second wireless STA to perform, during a sensing session, wireless sensing thereby obtaining sensing measurements, by performing measurements on frames received from said transmitter STA.

In an example, the first wireless STA comprises:
receive equipment arranged for receiving said obtained sensing measurements, or information derived from said obtained sensing measurements, from said sensing receiver STA.

It is noted that the advantages as explained with respect to the first aspect, being the method of performing sensing measurements during a sensing session between a first STA and a second STA are also applicable to the fourth aspect, being the first wireless STA, arranged for receiving sensing measurements from a second wireless STA, in a Wireless Communication Network.

In a sixth aspect, there is provided a computer program product comprising a computer readable medium having instructions stored thereon which, when executed by a wireless station, STA, in a wireless communication network, cause said wireless STA to implement a method in accordance with any of the method examples as provided above.

It is noted that the advantages as explained with respect to the first aspect, being the method of performing sensing measurements during a sensing session between a first STA and a second STA are also applicable to the fourth aspect, being computer program product.

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The above and other aspects of the disclosure will be apparent from and elucidated with reference to the examples described hereinafter.

### BRIEF DESCRIPTION OF THE FIGURES

FIG. 1 discloses an example of a method in accordance with the present disclosure;

FIG. 2 discloses an example of an architecture in accordance with the present disclosure;

FIG. 3 discloses an example of a wireless station in accordance with the present disclosure.

### DETAILED DESCRIPTION

It is noted that in the description of the figures, same reference numerals refer to the same or similar components performing a same or essentially similar function.

A more detailed description is made with reference to particular examples, some of which are illustrated in the appended drawings, such that the the features of the present disclosure may be understood in more detail. It is noted that the drawings only illustrate typical examples and are therefore not to be considered to limit the scope of the subject matter of the claims. The drawings are incorporated for facilitating an understanding of the disclosure and are thus not necessarily drawn to scale. Advantages of the subject matter as claimed will become apparent to those skilled in the art upon reading the description in conjunction with the accompanying drawings.

The ensuing description above provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment of the disclosure, it being understood that various changes may be made in the function and arrangement of elements, including combinations of features from different embodiments, without departing from the scope of the disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, electromagnetic, or a combination thereof. Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

These and other changes can be made to the technology in light of the following detailed description. While the description describes certain examples of the technology, and describes the best mode contemplated, no matter how detailed the description appears, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

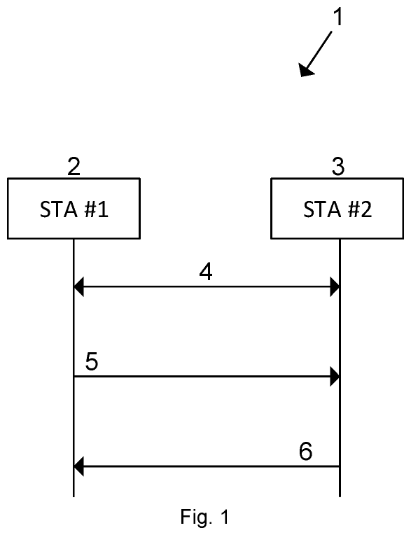

FIG. 1 discloses an example of a method 1 in accordance with the present disclosure

The method 1 is directed to performing, and optionally reporting, sensing measurements during a sensing session between a first wireless station, STA, 2 and a second wireless STA 3 in a wireless communication network, said method comprises the steps of:
selecting 4, in a sensing session setup, said first wireless STA as a sensing transmitter STA for transmitting frames, and said second wireless STA as a sensing receiver STA for performing measurements on frames received from said sensing transmitter STA, wherein said step of selecting is based on expected accuracy of said sensing measurements;
performing 5, by the sensing receiver STA, during a sensing session, wireless sensing thereby obtaining sensing measurements, by performing measurements on frames received from said sensing transmitter STA;
optionally, reporting 6, by the sensing receiver STA, said obtained sensing measurements to said sensing transmitter STA.

It is noted that it is not required that the obtained sensing measurement are reported back to the sensing transmitter STA. It may be sufficient to report a derivative of the obtained sensing measurements. For example, the sensing receiver STA may estimate the wireless channel between the sensing receiver STA and the sensing transmitter STA thereby obtaining complex valued Chanel State Information, CSI. In some cases, it may be sufficient to just report the amplitudes of those complex numbers back to the transmitter STA in stead of the complex numbers as such. In other examples, it may be sufficient to categorize the wireless channel based on the obtained complex valued CSI, and to report the categorization of the channel back to the sensing transmitter STA. In yet another example, the reporting may include specific modulation depths, or anything alike, as a proposal for the sensing transmitter STA to use during communication, etc. As such, the information that is reported back to the sensing transmitter STA may be a derivative of the obtained sensing measurements.

The inventors have found that often in wireless communications, the channel can be accurately modelled as reciprocal. That is, the channel, h, between two stations is the same independent of which one of the two stations is the transmitter and receiver, respectively.

The fact that the interference situation is very different for the transmitter and the receiver will effectively mean that the experienced channel conditions at the two stations can be very different although the channel is reciprocal. In addition, it may be so that the two involved stations have different capabilities when it comes to the maximum transmission power that can be supported.

When performing wireless sensing, one of the goals is to estimate the channel or possibly how the channel changes from a first instant of time to a second instant of time. With a reciprocal channel, it may seem as from a performance point of view it would not matter which one of the devices would be the sensing transmitter and which one would be the sensing receiver.

In fact, in prior art solutions, the decision concerning which station takes what role is typically based on practical things like which option would result in the least overhead or which device has the best computational capabilities.

However, even if the channel is reciprocal, the accuracy of the sensing measurement may be high unsymmetrical due to very different interference conditions. In particular, because the interference conditions may vary from one sensing instant to the next, it may be so at a first instant of time it may be preferred if STA 1 is the sensing transmitter and STA 2 is the sensing receiver whereas at a second instant of time better sensing accuracy is obtained if the roles are swapped.

Current standards for wireless sensing, e.g., IEEE 802.11bf does not take into account that the sensing performance can be very dependent on in which direction the sensing is performed. This implies that the sensing performance may not have sufficient accuracy and that certain applications simply will not work as intended.

The present disclosure is directed to methods to enable sensing to be performed in the direction giving improved reliable sensing results. Several examples are disclosed which allows for this to be achieved. According to one approach, the stations 1, 2 involved in the sensing do already at the set-up exchange information about the interference conditions and base the role selection at least in part on this information.

According to a second example, the stations 1, 2 interchange the roles of sensing transmitter station and sensing receiver station during a sensing session to ensure that some diversity is obtained.

In a third example, applicable when the stations 1, 2 support sensing on two or more links, different directions for sensing are selected for the at least two links.

In a fourth example, applicable when the stations 1, 2 involved in sensing support simultaneous transmission and reception, STR, the sensing is performed in both directions concurrently.

The above described insight enables improved sensing performance at very little additional overhead. The presented disclosure is applicable without any changes to the physical layer.

The sensing session setup-the sensing setup termination and measurement setup-measurement setup termination are one-to-one negotiations, while measurement instances and measurement reporting may be one-to-many or many-to-one. As an example of one-to-many, the announcement that a sensing PPDU will be transmitted can be done via a null data packet announcement, NDPA, transmitted by a sensing transmitter station and received by possibly many receiver stations.

Likewise, triggering channel sounding transmissions may be one-to-many, while the actual transmission of sensing PPDU, NDP, may be both one-to-many or many-to-one.

In the below, Wireless Local Area Network, WLAN, sensing is discussed, but as is obvious for anyone of ordinary skill in the art, the methods are equally well suited for other wireless communication networks. It is noted that the wireless communication network may also encompass an ad-hoc network, or an ad-hoc connection between the stations.

Further, different examples of the present disclosure are illustrated under the assumption that dedicated packets are used for sensing, here referred to as sensing PPDUs. Some of the examples may at least in part be applicable also when the sensing is performed on packets, or frames, that are not dedicated for sensing, but which carries user data.

A sensing measurement setup allows a sensing initiator and a sensing responder to agree on operational attributes associated with each measurement instance. Examples of operational attributes include determining the sensing transmitter/receiver, and the type of measurement report.

When the sensing initiator is different from the sensing receiver, the latter must feedback measurement reports to the initiator.

In a first example, the roles may be determined at sensing session setup as illustrated with reference numeral 4 in FIG. 1.

According to this example, the two wireless stations 2, 3 involved in the sensing will take the same roles throughout the whole sensing session. The sensing session is indicated with reference numeral 5.

The decision of which role to take, i.e., which one of the two stations 2, 3 should take the role of sensing transmitter station and which one should take the role of sensing receiver station, remains throughout the sensing session.

In order to take this decision, at least one of the involved stations 2, 3 informs the other station about some attribute, also referred to above as “other factors”, relevant for sensing performance.

Examples of such attributes may be maximum transmission power or interference conditions. In case of interference conditions, the information may e.g. relate to the average fraction of time that the corresponding station is interfered, the maximum interference that it is expected to experience, or an expected distribution for the interference it is expected to experience. The stations 2, 3 that receive this information may then decide which roles the two stations 2, 3 should take.

As an example, an Access Point, AP, is the sensing initiator and a non-AP station is a sensing responder. The AP may then request the AP to send information that is relevant for how well it can be expected to perform sensing measurements. The non-AP station sends this information to the AP and the AP then uses this for determining the roles by comparing with its own receiver conditions.

If, for example, the AP determines that the non-AP station has worse channel conditions than the AP, the AP may decide that the non-AP station should be the sensing transmitter whereas the AP becomes the sensing receiver. Conversely, if the AP determines that the non-AP station has more favourable channel conditions than the AP, the AP decides that the non-AP station will be the sensing receiver whereas the AP becomes the sensing transmitter.

In a second example, the sensing roles are alternated throughout a sensing session.

The above described example 1 may be suitable when the preferred direction for sensing remains the same during the entire session. However, to deal with situations where the preferred direction may change from one instant to the next, another approached is disclosed. According to this example, the two stations 2, 3 involved in sensing alternate the roles throughout the sensing session. As one specific example, a sensing event may be based on performing sensing in both directions so that in one sensing event stations 2 first takes the role of sensing transmitter and station 3 takes the role of sensing receiver. Then, in the next transmission, the roles are the opposite. In this way, a sensing decision in each sensing event will contain a sensing measurement in the most favourable direction.

As another example, the two stations 2, 3 may at the sensing session setup decide that during the first half of the session station 2 is the sensing transmitter, whereas during the second half of the session station 2 is the sensing receiver.

In a third example, the sensing is performed in different directions using multi-link transmission.

In some setups, the two stations 2, 3 involved in the sensing are both multi-link capable. In this case, each one of the involved station may have at least one sensing transmitter and one sensing receiver. That is, effectively one link is used for sensing in one direction whereas another link is used for sensing in the other direction. The choice of direction for the two links are preferably done by taking into account the interference conditions for the respective link.

It can also be noted that example 3 may be combined with both example 1 and example 2 in that example 1 and example 2 are applicable for how to do the sensing on the individual links. As an example, example 1 may be used for selecting the direction for the respective link, whereas example 2 may be used for both links in a multi-link scenario so that sensing measurements are performed in both directions on two or more links during one sensing session.

In a fourth example, the sensing is performed in different directions using simultaneous transmission and reception, STR.

In some other setups, the two involved stations 2, 3 are STR capable. According to this example, the two stations agree to use this capability to perform sensing in both directions concurrently/simultaneously. That is, each of the two stations may have both a sensing transmitter and a sensing receiver.

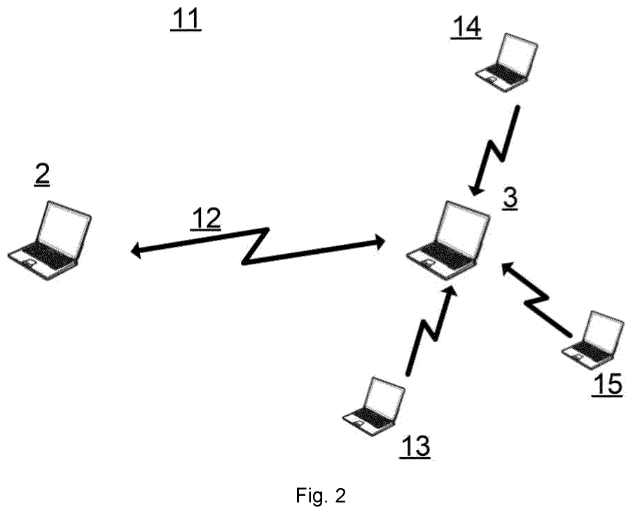

FIG. 2 discloses an example 11 of an architecture in accordance with the present disclosure.

The channel is indicated with reference numeral 12. It is shown that the interference that is experienced by the station 3 is different to the interference that is experienced by the station 2. This is because multiple stations 13, 14, 15 are in the vicinity of the station 3, wherein these multiple stations 13, 14, 15 may contribute significantly to the interference at the station 3. Such interference may be taken into account when deciding the roles for the two stations 2, 3.

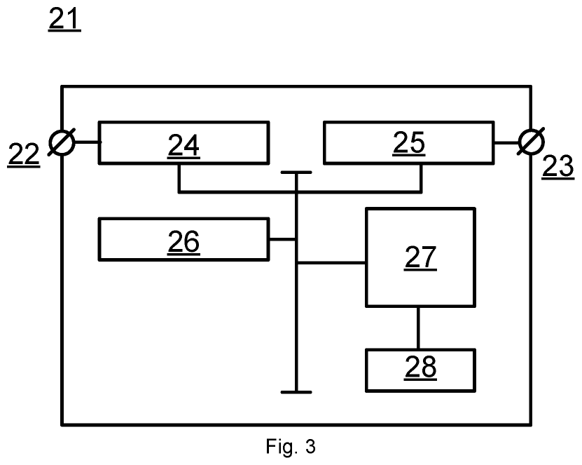

FIG. 3 discloses an example of a wireless station in accordance with the present disclosure.

The wireless station 21 may be a second wireless station. The second wireless STA, may be arranged for reporting sensing measurements to a first wireless STA, in a Wireless Communication Network, said second wireless STA comprises:
select equipment 26 arranged for selecting, in a sensing session setup, said first wireless STA as a sensing transmitter STA for transmitting frames, and said second wireless STA as a sensing receiver STA for performing measurements on frames received from said sensing transmitter STA, wherein said step of selecting is based on expected accuracy of said sensing measurements;
processing equipment 27 arranged for performing, during a sensing session, wireless sensing thereby obtaining sensing measurements, by performing measurements on frames received from said transmitter STA;
report equipment 25 arranged for reporting said obtained sensing measurements to said transmitter STA.

The second wireless station may further have receive equipment 24, wherein the receive equipment 24 and the report equipment 25 are connected to terminals 22, 23 for receiving, and transmitting, frames accordingly. Further a memory 28 may be coupled to the processing equipment 27.

The wireless station 21 may also be a first wireless station arranged for receiving sensing measurements from a second wireless STA, in a Wireless Communication Network, said first wireless STA comprises:
select equipment 26 arranged for selecting, in a sensing session setup, said first wireless STA as a sensing transmitter STA for transmitting frames, and said second wireless STA as a sensing receiver STA for performing measurements on frames received from said sensing transmitter STA, wherein said step of selecting is based on expected accuracy of said sensing measurements;
transmit equipment 25 arranged requesting said second wireless STA to perform, during a sensing session, wireless sensing thereby obtaining sensing measurements, by performing measurements on frames received from said transmitter STA;
receive equipment 24 arranged for receiving said obtained sensing measurements from said sensing receiver STA.

The first wireless station may further have the receive equipment 24, wherein the receive equipment 24 and the transmit equipment 25 are connected to terminals 22, 23 for receiving, and transmitting, frames accordingly. Further a memory 28 may be coupled to the processing equipment 27.

To reduce the number of claims, certain aspects of the technology are presented below in certain claim forms, but the applicant contemplates the various aspects of the technology in any number of claim forms. For example, while some aspect of the technology may be recited as a computer-readable medium claim, other aspects may likewise be embodied as a computer-readable medium claim, or in other forms, such as being embodied in a means-plus-function claim.

In the description above, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope thereof.

1.-41. (Canceled).

42. A method of performing sensing measurements during a sensing session between a first wireless station (STA) and a second wireless STA in a wireless communication network, the method comprising:
selecting, during a sensing session setup, the first wireless STA as a sensing transmitter STA for transmitting frames and the second wireless STA as a sensing receiver STA for performing measurements on frames received from the sensing transmitter STA, wherein the selection is based on expected accuracy of the sensing measurements; and
performing, by the sensing receiver STA during a sensing session, wireless sensing to obtain sensing measurements based on frames received from the sensing transmitter STA.

43. The method of claim 42, further comprising reporting, by the sensing receiver STA, the obtained sensing measurements to the sensing transmitter STA.

44. The method of claim 43, wherein the report of the obtained sensing measurements includes the following:
channel state information (CSI) field including the obtained sensing measurements; and
control field that describes how to interpret the CSI.

45. The method of claim 42, wherein the selection during the sensing session setup is further based on one or more of the following:
actual and/or expected interference experienced by any of the first wireless STA and the second wireless STA; and
a transmit power of any of the first wireless STA and the second wireless STA.

46. The method of claim 45, wherein the actual and/or expected interference is based on one of the following:
an average fraction of time that the first wireless STA and/or the second wireless STA is interfered;
a maximum interference that the first wireless STA and/or the second wireless STA is expected to experience; or
an expected distribution for the interference that the first wireless STA and/or the second wireless STA is expected to experience.

47. The method of claim 42, wherein selecting during the sensing session setup comprises selecting the following by the sensing receiver STA:
the first wireless STA as the sensing transmitter STA and the second wireless STA as the sensing receiver STA during a first part of the sensing session; and
the first wireless STA as the sensing receiver STA and the second wireless STA as the sensing transmitter STA during a second part of the sensing session.

48. The method of claim 42, wherein the first and second wireless STAs are capable of transmitting and/or receiving over two links simultaneously and selecting during the sensing session setup comprises selecting the following by the sensing receiver STA:
the first wireless STA as the sensing transmitter STA and the second wireless STA as the sensing receiver STA for a first of the two links; and
the first wireless STA as the sensing receiver STA and the second wireless STA as the sensing transmitter STA for a second of the two links,
wherein the wireless sensing is performed by the selected sensing receiver STA for both of the two links simultaneously during the sensing session.

49. A method for a first wireless station (STA) to request sensing measurements from a second wireless STA in a wireless communication network, the method comprising:
selecting, during a sensing session setup, the first wireless STA as a sensing transmitter STA for transmitting frames and the second wireless STA as a sensing receiver STA for performing measurements on frames received from the sensing transmitter STA, wherein the selection is based on expected accuracy of the sensing measurements; and
requesting the sensing receiver STA to perform wireless sensing during a sensing session to obtain sensing measurements based on frames received from the sensing transmitter STA.

50. The method of claim 49, further comprising receiving a report of the obtained sensing measurements from the sensing receiver STA.

51. The method of claim 50, wherein the report of the obtained sensing measurements includes the following:
channel state information (CSI) field including the obtained sensing measurements; and
control field that describes how to interpret the CSI field.

52. The method of claim 49, wherein the selection during the sensing session setup is further based on one or more of the following:
actual and/or expected interference experienced by any of the first wireless STA and the second wireless STA; and
a transmit power of any of the first wireless STA and the second wireless STA.

53. The method of claim 52, wherein the actual and/or expected interference is based on one of the following:
an average fraction of time that the first wireless STA and/or the second wireless STA is interfered;
a maximum interference that the first wireless STA and/or the second wireless STA is expected to experience; or
an expected distribution for the interference that the first wireless STA and/or the second wireless STA is expected to experience.

54. The method of claim 49, wherein selecting during the sensing session setup comprises selecting the following by the sensing transmitter STA:
the first wireless STA as the sensing transmitter STA and the second wireless STA as the sensing receiver STA during a first part of the sensing session; and
the first wireless STA as the sensing receiver STA and the second wireless STA as the sensing transmitter STA during a second part of the sensing session.

55. The method of claim 49, wherein the first and second wireless STAs are capable of transmitting and/or receiving over two links simultaneously and selecting during the sensing session setup comprises selecting the following by the sensing transmitter STA:
the first wireless STA as the sensing transmitter STA and the second wireless STA as the sensing receiver STA for a first of the two links; and
the first wireless STA as the sensing receiver STA and the second wireless STA as the sensing transmitter STA for a second of the two links,
wherein the wireless sensing is performed by the selected sensing receiver STA for both of the two links simultaneously during the sensing session.

56. A second wireless station (STA) arranged to perform sensing measurements during a sensing session between a first wireless STA and the second wireless STA in a wireless communication network, the second wireless STA comprising:
select equipment arranged to select, during a sensing session setup, the first wireless STA as a sensing transmitter STA for transmitting frames and the second wireless STA as a sensing receiver STA for performing measurements on frames received from the sensing transmitter STA, wherein the selection is based on expected accuracy of the sensing measurements; and
processing equipment arranged to perform, during a sensing session, wireless sensing to obtain sensing measurements based on frames received from the sensing transmitter STA.

57. The second wireless STA of claim 56, wherein the selection during the sensing session setup is further based on one or more of the following:
actual and/or expected interference experienced by any of the first wireless STA and the second wireless STA; and
a transmit power of any of the first wireless STA and the second wireless STA.

58. The second wireless STA of claim 57, wherein the actual and/or expected interference is based on one of the following:
an average fraction of time that the first wireless STA and/or the second wireless STA is interfered;
a maximum interference that the first wireless STA and/or the second wireless STA is expected to experience; or
an expected distribution for the interference that the first wireless STA and/or the second wireless STA is expected to experience.

59. The second wireless STA of claim 56, wherein the select equipment is arranged to select during the sensing session setup based on selecting the following:
the first wireless STA as the sensing transmitter STA and the second wireless STA as the sensing receiver STA during a first part of the sensing session; and
the first wireless STA as the sensing receiver STA and the second wireless STA as the sensing transmitter STA during a second part of the sensing session.

60. The second wireless STA of claim 56, wherein the first and second wireless STAs are capable of transmitting and/or receiving over two links simultaneously and the select equipment is arranged to select during the sensing session setup based on selecting the following:
the first wireless STA as the sensing transmitter STA and the second wireless STA as the sensing receiver STA for a first of the two links; and
the first wireless STA as the sensing receiver STA and the second wireless STA as the sensing transmitter STA for a second of the two links,
wherein the wireless sensing is performed by the selected sensing receiver STA for both of the two links simultaneously during the sensing session.

61. A first wireless station (STA) arranged to request sensing measurements from a second wireless STA in a wireless communication network, the first wireless STA comprising:
select equipment arranged to select, during a sensing session setup, the first wireless STA as a sensing transmitter STA for transmitting frames and the second wireless STA as a sensing receiver STA for performing measurements on frames received from the sensing transmitter STA, wherein the selection is based on expected accuracy of the sensing measurements; and
transmit equipment arranged to request the sensing receiver STA to perform wireless sensing during a sensing session to obtain sensing measurements based on frames received from the sensing transmitter STA.

62. The first wireless STA of claim 61, further comprising receive equipment arranged to receive a report of the obtained sensing measurements from the sensing receiver STA, wherein the report of the obtained sensing measurements includes the following:
channel state information (CSI) field including the obtained sensing measurements; and
control field that describes how to interpret the CSI field.

63. The first wireless STA of claim 61, wherein the selection during the sensing session setup is further based on one or more of the following:
actual and/or expected interference experienced by any of the first wireless STA and the second wireless STA; and
a transmit power of any of the first wireless STA and the second wireless STA.

64. The first wireless STA of claim 63, wherein the actual and/or expected interference is based on one of the following:
an average fraction of time that the first wireless STA and/or the second wireless STA is interfered;
a maximum interference that the first wireless STA and/or the second wireless STA is expected to experience; or
an expected distribution for the interference that the first wireless STA and/or the second wireless STA is expected to experience.

65. The first wireless STA of claim 61, wherein the select equipment is arranged to select during the sensing session setup based on selecting the following:
the first wireless STA as the sensing transmitter STA and the second wireless STA as the sensing receiver STA during a first part of the sensing session; and
the first wireless STA as the sensing receiver STA and the second wireless STA as the sensing transmitter STA during a second part of the sensing session.

66. The first wireless STA of claim 61, wherein the first and second wireless STAs are capable of transmitting and/or receiving over two links simultaneously and the select equipment is arranged to select during the sensing session setup based on selecting the following:
the first wireless STA as the sensing transmitter STA and the second wireless STA as the sensing receiver STA for a first of the two links; and
the first wireless STA as the sensing receiver STA and the second wireless STA as the sensing transmitter STA for a second of the two links,
wherein the wireless sensing is performed by the selected sensing receiver STA for both of the two links simultaneously during the sensing session.
